(19) United States
(12) Patent Application Publication
(10) Pub. No.: US 2017/0262163 A1
(43) Pub. Date: Sep. 14, 2017

(54) APPARATUS, METHOD AND STORAGE MEDIUM FOR CORRECTING PAGE IMAGE

(71) Applicant: CASIO COMPUTER CO., LTD., Tokyo (JP)

(72) Inventor: Ryo NIMURA, Tokyo (JP)

(73) Assignee: CASIO COMPUTER CO., LTD., Tokyo (JP)

(21) Appl. No.: 15/357,695

(22) Filed: Nov. 21, 2016

(30) Foreign Application Priority Data
Mar. 11, 2016 (JP) 2016-048180

(51) Int. Cl. G06F 3/0484; G06F 3/0483; G06T 5/00; G06F 3/0488; G06T 3/00; G06T 3/60

(52) U.S. Cl. CPC G06F 3/04845; G06T 3/0056; G06T 3/0093; G06T 3/60; G06T 5/006; G06F 3/04883; G06F 3/0483; G06F 2203/04104

(57) ABSTRACT

When a touch operation is performed with one finger, this touch operation performed with one finger is judged to be a single-point operation performed on one control point on a mesh image constituted by Bezier curves and deformation processing is performed in which the corresponding point is moved in accordance with the movement of the one touching finger. On the other hand, when a touch operation is performed with a plurality of fingers, it is judged to be a multi-point operation performed on all control points on the mesh image constituted by Bezier curves , and deformation processing is performed in which all the control points on the mesh image are moved in accordance with the movements of the plurality of fingers with the linearity of the mesh image being maintained.

### CROSS-REFERENCE TO RELATED APPLICATION

This application is based upon and claims the benefit of priority from the prior Japanese Patent Application No, 2016-048180, filed Mar. 11, 2016, the entire contents of which are incorporated herein by reference

### BACKGROUND OF THE INVENTION

1. Field of the Invention

The present invention relates to an apparatus, a method and a storage medium for correcting a page image.

2. Description of the Related Art

Conventionally, a technique has been proposed in which pages of a book are turned to be photographed by a camera and thereby digitized without being cut. However, when a book is opened and photographed from above in a normal state, character strings and diagrams in an image acquired thereby are distorted due to the curl of the pages of the book.

Accordingly, for example, a technique has been proposed in Japanese Patent Application Laid-Open (Kokai) Publication No. 2014-192901 in which an application program for image processing displays a mesh image on a distorted page image, controls the mesh image such that it coincides with the curve of the page, and performs curvature correction on the distortion of the page image based on the mesh image. Also, a technique has been proposed in Japanese Patent Application Laid-Open (Kokal) Publication No. 2015-119431 in which trapezoid correction is performed on the distortion of a page image based on the above-described mesh image. However, in these techniques, although control points on a mesh image can be independently operated (moved), straight portions of the mesh image cannot be maintained when the mesh image is deformed by the control points being operated.

### SUMMARY OF THE INVENTION

In accordance with one aspect of the present invention, there is provided an apparatus for correcting a page image, comprising: a display control section which displays a processing target image and a mesh image superimposed thereon, on an input display section having a display function and a touch input function; a detection section which detects a touch operation performed on the input display section by a user; a judgment section which judges whether the touch operation detected by the detection section is a single-point operation for operating one control point from among a plurality of control points on Bezier curves constituting the mesh image or a multi-point operation for operating the plurality of control points simultaneously; a first deformation section which deforms shape of the mesh image by moving the one control point specified by the touch operation from among the plurality of control points in accordance with the touch operation, when the judgment section judges that the touch operation is a single-point operation; a second deformation section which deforms the shape of the mesh image by moving the plurality of control points under a same condition in accordance with the touch operation, when the judgment section judges that the touch operation is a multi-point operation; and a correction section which corrects shape of the processing target image based on the shape of the mesh image deformed by the first deformation section and the second deformation section.

In accordance with another aspect of the present invention, there is provided a method for correcting shape of a processing target image, comprising; displaying the processing target image and a mesh image superimposed thereon, on an input display section; detecting a touch operation performed on the input display section by a user; judging whether the detected touch operation is a single-point operation for operating one control point from among a plurality of control points on Bezier curves constituting the mesh image or a multi-point operation for operating the plurality of control points simultaneously; deforming shape of the mesh image by moving the one control point specified by the touch operation from among the plurality of control points in accordance with the touch operation, when the touch operation is judged to be a single-point operation; deforming the shape of the mesh image by moving the plurality of control points under a same condition in accordance with the touch operation, when the touch operation is judged to be a multi-point operation; and correcting the shape of the processing target image based on the deformed shape of the mesh image.

In accordance with one aspect of the present invention, there is provided a non-transitory computer-readable storage medium having stored thereon a program that is executable by a computer to actualize functions comprising: displaying a processing target image and a mesh image superimposed thereon, on an input display section; detecting a touch operation performed on the input display section by a user; judging whether the detected touch operation is a single-point operation for operating one control point from among a plurality of control points on Bezier curves constituting the mesh image or a multi-point operation for operating the plurality of control points simultaneously; deforming shape of the mesh image by moving the one control point specified by the touch operation from among the plurality of control points in accordance with the touch operation, when the touch operation is judged to be a single-point operation; deforming the shape of the mesh image by moving the plurality of control points under a same condition in accordance with the touch operation, when the touch operation is judged to be a multi-point operation; and correcting the shape of the processing target image based on the deformed shape of the mesh image.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more deeply understood by the detailed description below being considered together with the following drawings

FIG. 1 is a perspective view showing a schematic structure of an example of a document camera system 1 according to an embodiment;

FIG, 2 is a perspective view showing a schematic structure of another example of the document camera system 1 according to the embodiment;

FIG, 3 is a block diagram showing a schematic structure of an information processing terminal 7 according to the embodiment;

FIG. 4 is a flowchart for describing correction processing by the information processing terminal 7 according to the embodiment;

FIG. 5A and FIG. 58 are schematic diagrams for describing touch operations for deforming a mesh image 9 according to the embodiment;

FIG. 6 is a schematic diagram for describing a touch operation for deforming the mesh image 9 according to the embodiment by operating control points 80 individually;

FIG. 7A, FIG. 78, and FIG. 7C are schematic diagrams for describing a touch operation for elongating or contracting the mesh image 9 according to the embodiment by operating all control points 80 simultaneously;

FIG. 8A and FIG. 88 are schematic diagrams for describing a touch operation for rotating the mesh image 9 according to the embodiment by operating all control points 80 simultaneously;

FIG. 9A and FIG. 98 are schematic diagrams for describing a touch operation for moving the mesh image 9 according to the embodiment by operating all control points 80 parallelly and simultaneously; and

FIG. 10A and FIG. 10B are schematic diagrams for describing a touch operation using three fingers for rotating the mesh image 9 according to the embodiment.

### DETAILED DESCRIPTION OF THE PREFERRED EMBODIMENTS

### A. First Embodiment

An embodiment of the present invention will hereinafter be described with reference to the accompanying drawings. Note that , although the embodiment described below is provided with various technically preferable limitations in order to carry out the present invention, these limitations are not intended to limit the scope of the present invention to the embodiment and examples shown in the drawings.

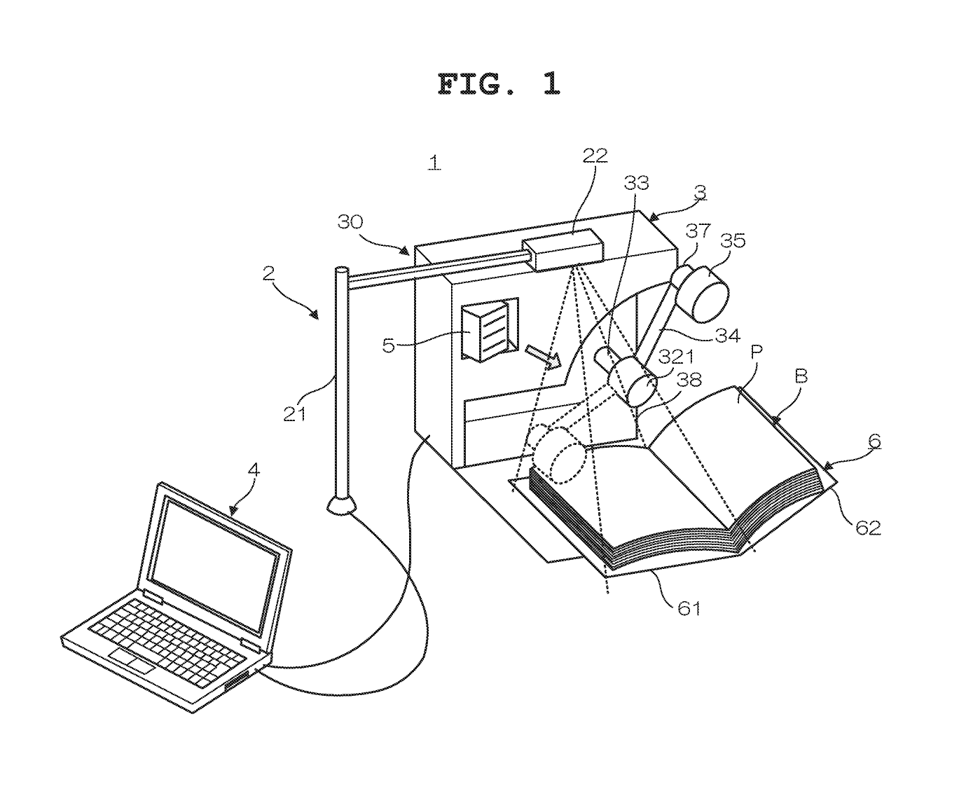

FIG. 1 is a perspective view showing a schematic structure of an example of a document camera system I according to an embodiment. Note that in the following descriptions a case is exemplarily described in which pages of a book are turned from left to right. This document camera system 1 includes a document camera 2 as imaging means for photographing pages P of a book B, a page turning apparatus 3 which turns pages P of the book B, and a personal computer 4 which is connected to the document camera 2 and the page turning apparatus 3 such that it can communicate with them, as shown in FIG. 1.

The document camera 2 is provided with a stand section 21 and a camera 22 attached to the upper end of the stand section 21. The stand section 21 is tiltable in the front-and-back direction and the right-and-left direction and is vertically extendable so that the relative positional relationship between the book B and the camera 22 can be adjusted. The lens of the camera 22 is oriented downward so that the book B is within the viewing angle of the lens. In the joint portion between the camera 22 and the stand section 21, a positioning mechanism is provided, whereby the orientation of the lens of the camera 22 can be adjusted,

The page turning apparatus 3 includes a holding table 6 which holds the opened book B, and a page turning apparatus body 30 which holds pages P of the book Es on the holding table 6 at a page-turning start point and releases each page P at a page-turning end point.

The holding table 6 includes a pair of holding plates 61 and 62 which is foldable by a hinge not shown. In this embodiment , in the case where the pages P of the book B are turned from left to right, one holding plate 61 of the pair of holding plates 61 and 62 which is located on the left side is placed along the surface of the table, and the other holding plate 62 located on the right side is placed obliquely upward on the table at a predetermined tilt angle with respect to the holding plate 61. On the holding plate 61, Pages P that serve as a page-turning start point of the book B are placed. On the other holding plate 62 , pages P that serve as a page-turning end point of the book B are placed.

Accordingly, the holding table 6 holds the book B such that the pages p at the page-turning end point tilt in a direction to rise with the seam of the book B as an axis, as compared to the pages P at the page-turning start point, Note that since the pair of holding plates 61 and 62 is foldable by the hinge, an angle between the pair of holding plates 61 and 62 can be adjusted, and a tilt angle with respect to the horizontal plane of a page P at the page-turning end point can be freely adjusted,

The page turning apparatus body 30 includes an arm section 34 which swings around a driving shaft 33, a sticking section 35 which is attached to a distal end of the arm section 34 and sticks to a page P of the book B, a pedestal section 38 which supports the arm section 34 and the sticking section 35, an air blowing section 5 which blows air against a page P at a page-turning end point by making air pass above a page P at a page turning start point, and a control section not shown which controls the respective sections.

As shown in FIG. 1, a rotating body 321 is attached to a distal end portion of the driving shaft 33, and the arm section 34 is attached to the rotating body 321 in a manner to extend along a horizontal plane perpendicular to the driving shaft 33. The arm section 34 is, for example, a rectangular plate-like member made of resin, and a sectional portion of the arm section 34 which is perpendicular to the longitudinal direction has a flat plate-like shape. The sticking section 35 is attached to a distal end of the arm section 34 through a driving section 37 such as a motor. This sticking section 35 is an adhesive section having a substantially columnar shape.

FIG. 2 is a perspective view showing a schematic structure of another example of the document camera system 1 according to the embodiment. Note that sections corresponding to those in FIG, 1 are provided with the same reference numerals, and descriptions thereof are omitted. The only difference between the document camera system 1 in FIG. 2 and that in FIG. 1 is that the document camera system 1 in FIG. 2 does not include the document camera 2 and the personal computer 4 which is connected to and can communicate with the document camera 2 and the page turning apparatus 3, and the page turning apparatus 3 itself is the same as that in FIG. 1. In the document camera system 1 in FIG. 2, a smartphone, a tablet terminal, or the like (hereinafter referred to as an information processing terminal 7) equipped with a camera section is used in place of the document camera 2 and the personal computer 4. The information processing terminal 7 is arranged on a placement table 8 such as a table having a flat surface at a suitable height. This information processing terminal 7 is placed face down such that its display section 71 is oriented upward and its imaging section is oriented downward so that the book B is within the viewing angle. The imaging section 72 is in the upper center or upper corner (right corner when viewed from the display section 71 side) of the information processing terminal 7.

In both of the structures of FIG. I and FIG, 2, in a page turning operation, the arm section 34 is first moved to the page-turning start point side of the pages P on the holding plate 61 side, so that the sticking section 35 sticks to a page P at the page-turning start point. Then, the arm section 34 is moved to the page-turning end point on the holding plate 62 side with the sticking section 35 sticking to the page P. As a result this page P is moved to the page-turning end point along with the forward movement of the arm section 34. Then, at this page-turning end point, it comes unstuck by the sticking section 35 being rotated. Here, at predetermined timing, a page P on the holding plate 61 side which has not yet been turned over is photographed by the imaging section 72 of the camera 22 or the information processing terminal 7. Then, the arm section 34 is moved in a direction opposite to that of the forward movement toward the page-turning start point side on the holding plate 61 side, so that the sticking section 35 sticks to this new page P (photographed page) on the page-turning start point side. By this reciprocation operation being repeated, page turning operations for the pages P are progressed.

Here, until the last page P is reached, all pages P (such as odd-numbered pages) on one side of the book B. are photographed. Image data acquired thereby are numbered for each page P (each imaging operation), transmitted to a CPU (Central Processing Unit) 77 (which is described later) of the personal computer 4 or the information processing terminal 7, and stored in a predetermined storage section or the like. Then, the user inverts the book B, places it on the holding table 6, and causes the above-described page turning operations to he performed again. As a result, until the last page P is reached, all pages P (such as even-numbered pages) on the other side of the book B are photographed. Then, as described above, image data acquired thereby are numbered for each page P (each imaging operation), transmitted to the CPU 77 (which is described later) of the personal computer 4 or the information processing terminal 7, and stored in the predetermined storage section or the like. Then, the images of the odd-numbered pages P and the even-numbered pages P are alternately rearranged in page order so as to be compiled as scan images of all the pages P.

At this stage, in the image data of each page P, the whole page P, and images, character strings, and diagrams on the page P are distorted due to the curl and the like of the page P sf the book B. Accordingly, in the personal computer 4 or the information processing terminal 7, the image distortion is corrected by curvature correction and trapezoid correction being performed using a predetermined application program. In the descriptions below, as a device for performing image processing such as the curvature correction and the trapezoid correction, the information processing terminal 7, which is a smartphon.e, a tablet terminal, or the like, is used. However, it goes without saying that, by a similar software program (application program), the same processing can be achieved by the personal computer 4 although its hardware configuration is different therefrom.

FIG. 3 is a block diagram showing a schematic structure of the information processing terminal 7 according to the present embodiment. The information processing terminal 7 in FIG. 3 includes a communication section 70, a display section 71, an imaging section 72, a ROM (Read-Only Memory) 73, a RAM (Random Access Memory) 74, an operation section (touch panel) 75, a storage medium 76, and the CPU 77. The communication section 70 connects the information processing terminal 7 to a network such as the Internet by using mobile communication, Bluetooth (registered trademark), wireless LAN (Wi-Fi (Wireless Fidelity)), or the like. The imaging section 72 includes a lens block constituted by an optical lens group and an image sensor such as a CCD (Charge-Coupled Device) or a CMOS (Complementary Metal Oxide Semiconductor), and captures images entering from the lens block by the image sensor. In the present embodiment , this imaging section 72 photographs the pages P of the book B. Note that the CPU may be a processor or the like.

The ROM 73 stores programs to be executed by the CPU 77 described later, various parameters required for operations, and the like. The RAM 74 stores data, such as temporary data when a program is executed by the CPU 77, various application programs , various parameters required for the execution of the application programs. In particular, in this embodiment, the RAM 74 stores captured images, corrected images, and the like.

The display section 71 is constituted by a liquid crystal display, an organic EL (Electro Luminescence) display, etc., and displays icons associated with specific functions and application programs, application screens, various menu screens, and the like. The operation section (touch panel) 75 detects direct contact by a finger or a stylus (pen) or the approach thereof, Note that the operation section (touch panel) 75 may include mechanical switches, such as a power button and a sound-volume button, In particular, in the present embodiment, by the user performing a touch operation on the operation section (touch panel) 75, control points 80 on a mesh image 9 superimposed and displayed on a captured page image on the display section 71 are individually moved, or are moved closer to or away from each other, moved to be rotated, or moved in parallel with the straight portions of the mesh image 9 being maintained, whereby the shape of the mesh image 9 is deformed to coincide with the shape of the page image. Also, the display section 71 may have both a display function and a touch input function, so that a touch operation for deforming the shape of the mesh image 9 to coincide with the shape of a page image can be inputted by the user's touch operation on the display section 71.

The storage medium 76 stores various data, such as captured image data. The CPU 77 controls the operations of each section by executing the programs stored in the above-described ROM 73. In particular, in the present embodiment the CPU 77 performs curvature correction processing and trapezoid correction processing for correcting the deformation, curvature, and the like of a page image by executing an image processing program.

That is, the CPU 77 performs the curvature correction processing and the trapezoid correction processing by which the shape of the mesh image 9 is deformed with the shape of a page image such that the mesh image 9 deformed by the user's touch operation has the correct shape (rectangle).

The curvature correction processing is processing in which, if an original, page image is curved and distorted, this curvature distortion is corrected so that the shape of the image returns to its original shape. On the other hand, the trapezoid correction processing is processing in which, if an original page image is trapezoidally distorted with its linearity being maintained, this trapezoidal distortion is corrected so that the shape of the image returns to its original shape. Note that the curvature correction processing and the trapezoid correction are known techniques and therefore explanations thereof are omitted herein.

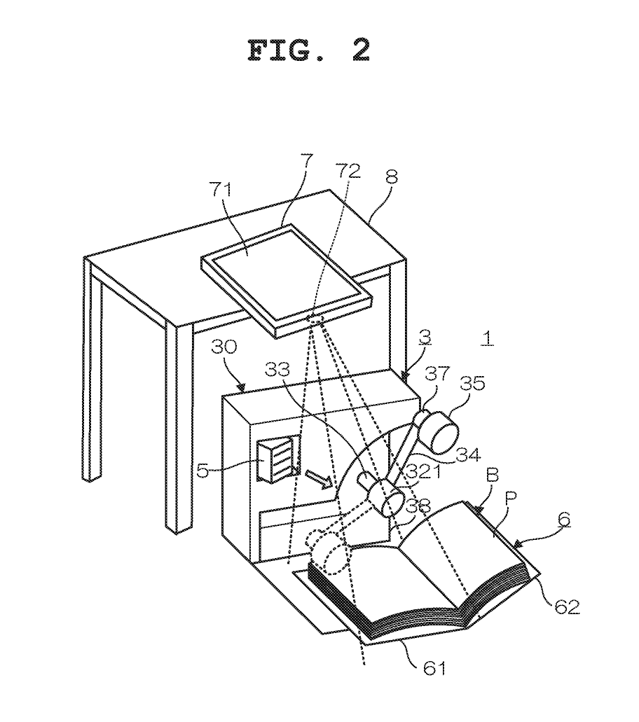

FIG. 4 is a flowchart for describing correction processing by the information processing terminal 7 according to the present embodiment. Note that, in the example herein, page images of all the pages P of the book B have already been stored in the storage medium 76 of the information processing terminal 7 in page order as image data in a predetermined format. The user instructs the information processing terminal 7 to perform the image correction processing after photographing the pages P of the book B.

First, the CPU 77 acquires a first page image of the book B from the recording medium 76 and stores it in the RAM 74. Subsequently, the CPU 77 outputs, on the display section 71, the page image and an initial undistorted mesh image 9 superimposed on the page image (Step S10). Then, the CPU 77 judges whether the user has performed a touch operation on the operation section (touch panel) 75 (Step S12), When judged that no touch operation has been performed (NO at Step S12) the CPU 77 returns to Step S10, and continues the display of the page image and the mesh image 9.

Conversely, when judged that the user has performed a touch operation on the operation section (touch panel) 75 (YES at Step S12), the CPU 77 judges whether the user has touched it with one finer or touched it with two or more fingers. That is, the CPU 77 judges whether the touch operation is a touch operation using one finger or a touch operation using two or more fingers (Step S14).

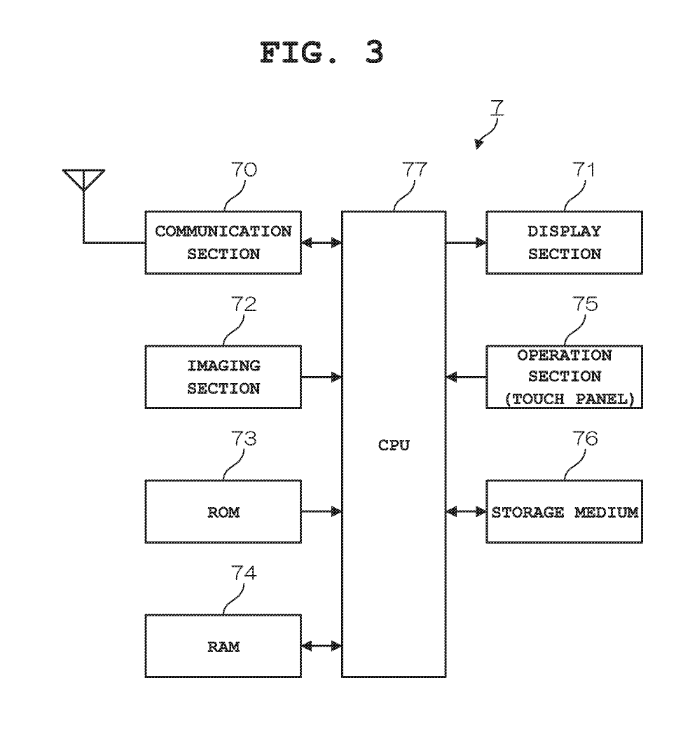

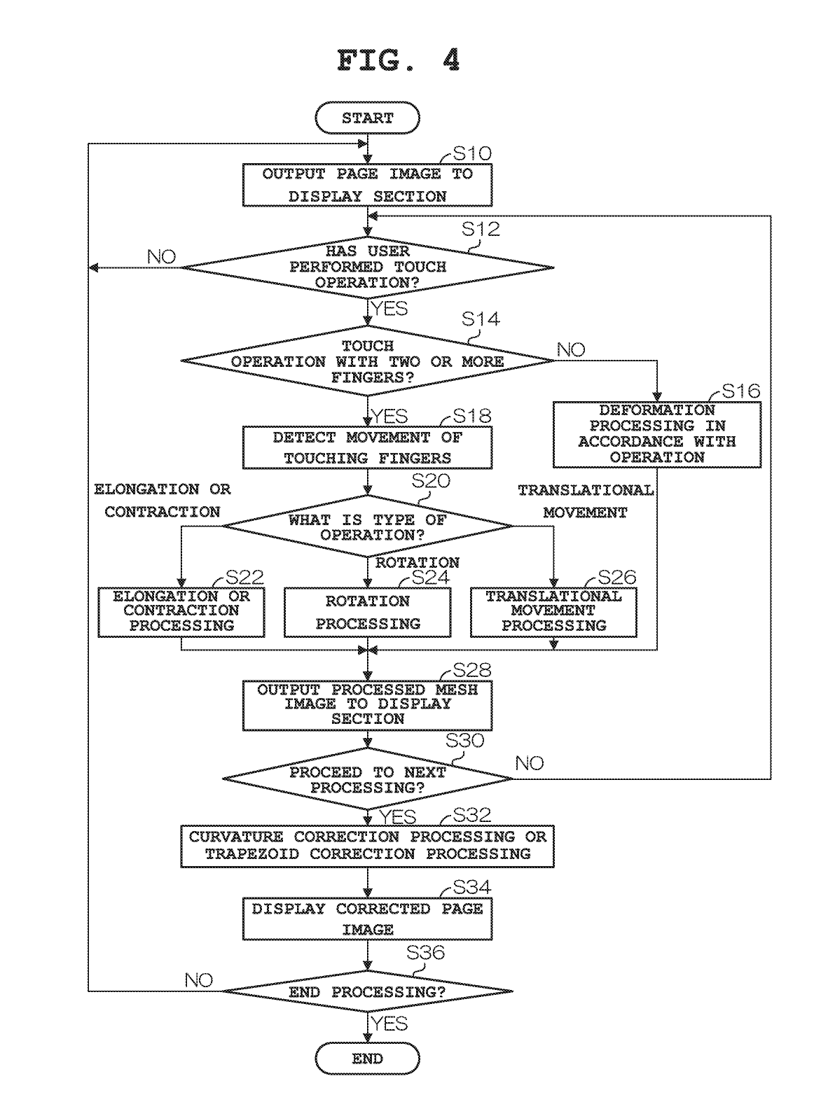

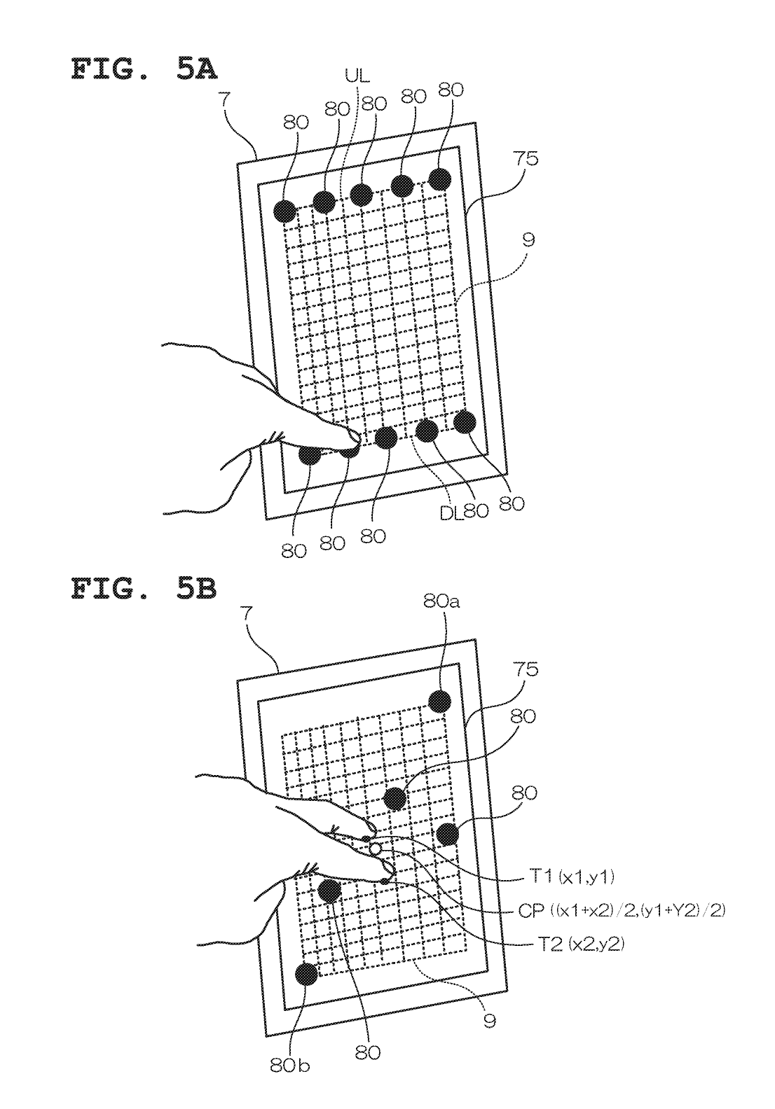

FIG. 5A and FIG. 5B are schematic diagrams for describing touch operations for deforming the mesh image 9 according to the present embodiment. When wishing to deform the shape of the mesh image 9 itself, or in other words, when wishing to operate control points 80 on the mesh image 9 individually, the user touches a control point 80 on a portion to be deformed (all the black circles in the drawing are control points 80) with one finger, and drags the finger (slides the finger while touching the control point 80) in a direction in which the user wishes to move the control point 80 (single-point operation). That is, in this single-point operation, one control point 80 among a plurality of control points 80 (there are five points in each of the upper and lower portions of the mesh image 9 in the present embodiment) on the mesh image 9 constituted by Bezier curves is operated (moved).

As shown in FIG. 5A, the user elongates or contracts the shape of the mesh image 9 superimposed and displayed on a page image by touch operations so that it coincides with the shape of the page image. When the user moves control points 80 such that the shape of the mesh image 9 coincides with the shape of the page image, the shape of the mesh image 9 is deformed in real time along with the movements of the control points 80.

An upper line UL at the upper most portion of the mesh image 9 and a lower line DL at the lowermost portion are drawn using guartic Bezier curves. By five control points 80 on the upper line UL and five control points 80 on the lower line DL being respectively moved, the upper line UL and the lower line DL can be freely moved. The CPU 77 derives the widths of horizontal lines and vertical lines between the upper line UL and the lower line DL and the curving conditions of curved lines by using a predetermined mesh generation algorithm with reference to the upper line UL and the lower line DL, and deforms the shape of the mesh image 9 in real time.

Note that, although the total number of the upper and lower control points 80 for deforming the mesh image 9 is ten in the present embodiment, the present invention is not limited thereto and a configuration may be adopted in which the intersection points of a plurality of areas constituting the mesh image 9 are used as control points 80, Also, points to be touched are not limited to the upper line UL and the lower line DL, and a configuration may be adopted in which the user performs a touch operation on a portion to be deformed and an intersection point on this portion and surrounding intersection points are used as control points 80 for deformation. In this configuration, in order to indicate that these intersection points are available as control points 80, their dots may be enlarged or their color may be changed.

On the other hand, when wishing to elongate or contract, rotate, or translate the mesh image 9 while maintaining its straight portions without deforming its shape, or in other words, when wishing to move all the control points 80 on the mesh image 9 simultaneously, the user performs a predetermined operation (multi-point operation) while touching the mesh image 9 with two or more fingers, as shown in FIG. 5B. More specifically, in this multi-point operation, all the control points 80 (all the black circles in the drawing are control points 80; and there are five control points 80 in the example of the drawing) are operated (moved closer to or away from each other, rotated, or moved in parallel) simultaneously (without their relative positions being changed)

As described above, on the screen of the display section 71, the mesh image 9 constituted by Bezier curves is displayed with a captured page image (not shown), and there are five control points 80 on each of the upper and. lower (quartic) Bezier curves constituting the mesh image 9. Note that the mesh image 9 itself is a user interface formed by curved lines, and is not directly related to the curvature correction processing and the trapezoid correction processing described later. That is, in the curvature correction processing and the trapezoid correction processing, control points 80 are movement targets, and therefore control points 80 to be moved are required to be identified from the positions of fingers used in a touch operation.

This identification is described using an example having five control points 80 as shown in FIG. 5B First, the coordinates of a rectangle including all of the five control points 80 are derived in advance. In the derivation of the rectangle, a control point whose abscissa (x-coordinate) is minimum among the five control points (control point 80b in the example of the drawing), a control point whose abscissa is maximum (control point 80a in the example of the drawing) a control point whose ordinate (y-coordinate) is minimum (control point 80b in the example of the drawing), and a control point whose ordinate is maximum (control point 80a in the example of the drawing) are acquired, and the upper, lower, left, and right sides of the rectangle are constituted based on the minimum values and the maximum values. Note that , although the shape of the rectangle and the contour of the mesh image 9 coincide with each other in the example of the drawing, the present invention is not limited thereto.

Next, a geometrical center point CP in. FIG. 5$ which is located between two or more fingers used for a touch operation is calculated. When this center point CP is within the rectangle, a judgment is made that all the control points 80 within the rectangle are simultaneously moved closer to or away from each other, rotated, or moved in parallel (without their relative positions being changed)

In the method for calculating the center point CP, the coordinates of the positions of all the fingers used for the touch operation are measured. Then, by use of these values, the average of the x-coordinates and the average of the y-coordinates are acquired. The example shown in FIG, 5B is an example where a touch operation has been performed with two fingers, For example, when the touch position T1 of a first finger is (x1, y1) and the touch position T2 of the second finger is (x2, y2), the coordinates of the center point CP of these two fingers are ((x1+x2)/2, (y1+y2)/2). As such, based on the coordinates of the center point CP of the two fingers and the coordinates of the rectangle including the five control points 80, whether the center point CP is within the rectangle can be judged.

At Step S14, when the touch operation has been performed with one finger as shown in FIG. 5A (NO at Step S14), the CPU 77 judges that it is a single-point operation performed by a touch operation with one finger on a control point 80 on the mesh image 9 constituted by Bezier curves, and performs deformation processing for moving this control point 80 in accordance with the movement of the touching finger (Step S16)

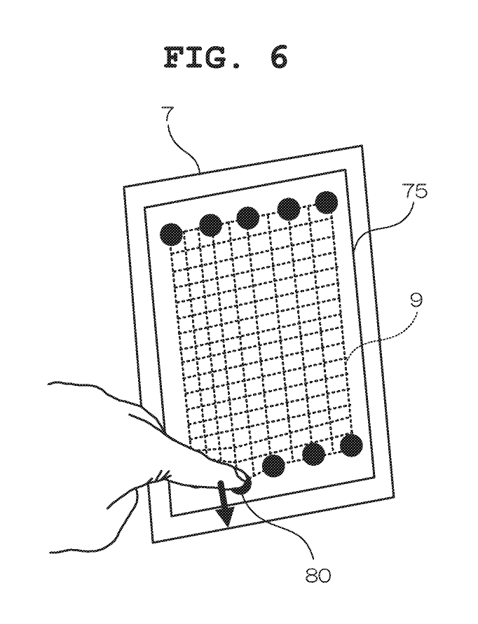

FIG. 6 is a schematic diagram for describing a touch operation for deforming the mesh image 9 according to the present embodiment by operating control points 80 individually. Specifically, the user touches a control point 80 with a finger and moves the finger in a direction in which the shape of the mesh image 9 is deformed to coincide with the shape of a page image, as shown in FIG. 6. Here, the CPU 77 moves the control point 80 on the mesh image 9 constituted by Bezier curves in accordance with the movement direction and the movement amount of the touching finger, and the shape of the mesh image 9 is deformed in real time along with the movement of the control point 80.

Although details will be described later, the user can deform the shape of the mesh image 9 by moving a control point 80 by a touch operation with one finger so as to increase or decrease the level of curvature correction or to make partial adjustment while checking the movement of the control point 80 in real time.

At Step S14, when the touch operation has been performed with two or more fingers (YES at Step S14), the CPU 77 detects the operation (movement) of the touching fingers (Step S18), and judges the type of the operation (Step S20). In this embodiment, in the case of a touch operation with two fingers, it is judged whether the touch operation is an (elongation or contraction) operation where the distance between the two fingers is changed, an (rotation) operation where the two fingers are rotated (in an arc) around the center point therebetween with their relative positions being maintained, or an (translational movement) operation where the two fingers are moved with their relative positions being maintained.

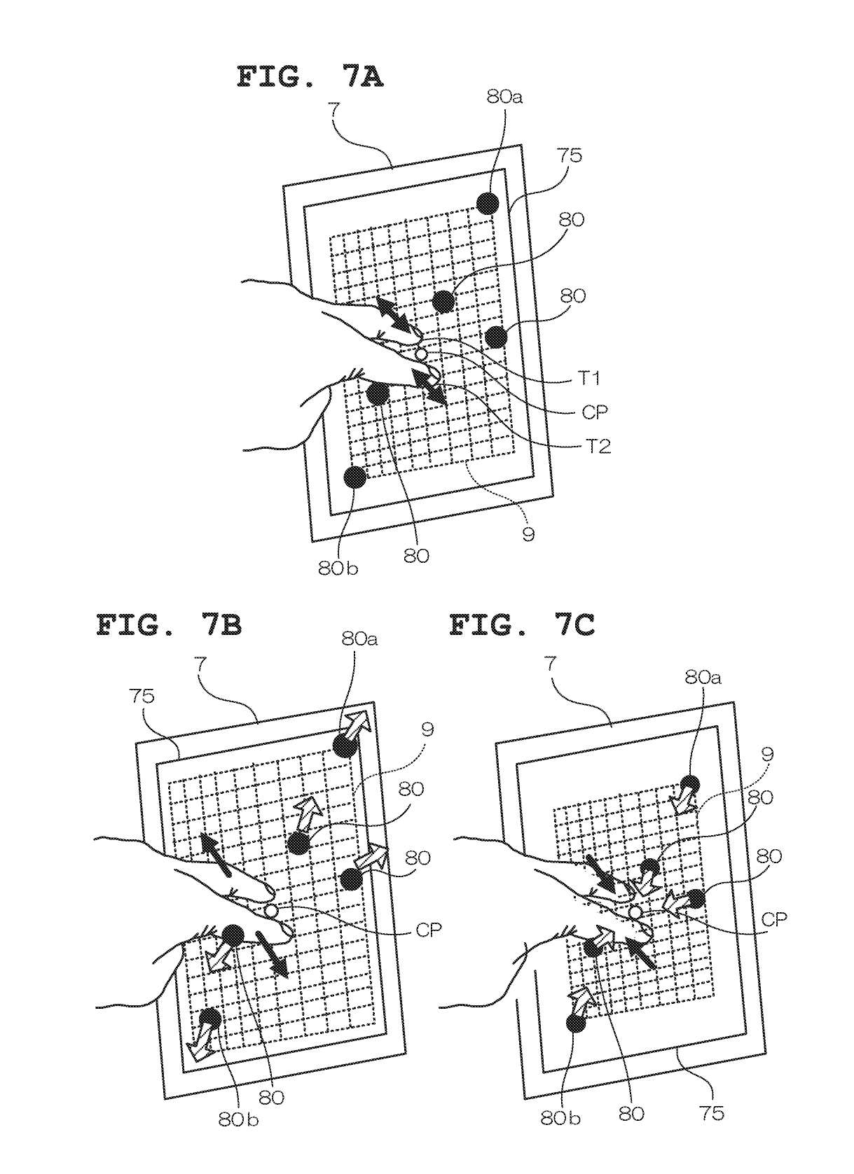

Here, the elongation and contraction, the rotation, and the translational movement are described. FIG. 7A, FIG, 7B, and FIG, 7C are schematic diagrams for describing a touch operation for elongating or contracting the mesh image 9 according to the present embodiment by operating all control points 80 simultaneously. In the elongation or contraction operation, the control points 80 are moved closer to or away from each other. By this elongation or contraction operation, the size of the mesh image 9 constituted by Bezier curves can be enlarged or reduced with its shape being maintained. That is, it is an operation called a pinch-in and pinch-out operation for touch devices such as smartphones and tablet computers, Here, the coordinates of points T1 and T2 touched with two fingers and the coordinates of a center point CP between the two fingers are measured for several frames from the start of the touch operation. Then, when the center point CP is determined to be not moving and be within an allowable range, and movement vectors caused by the points T1 and. T2 touched with the two fingers being moved closer to or away from each other in a radial direction from the center point CP within an allowable range, or in other words, movement vectors caused by the touched points T1 and T2 being moved in directions opposite to each other are detected, the users s touch operation is judged to be an elongation or contraction operation,

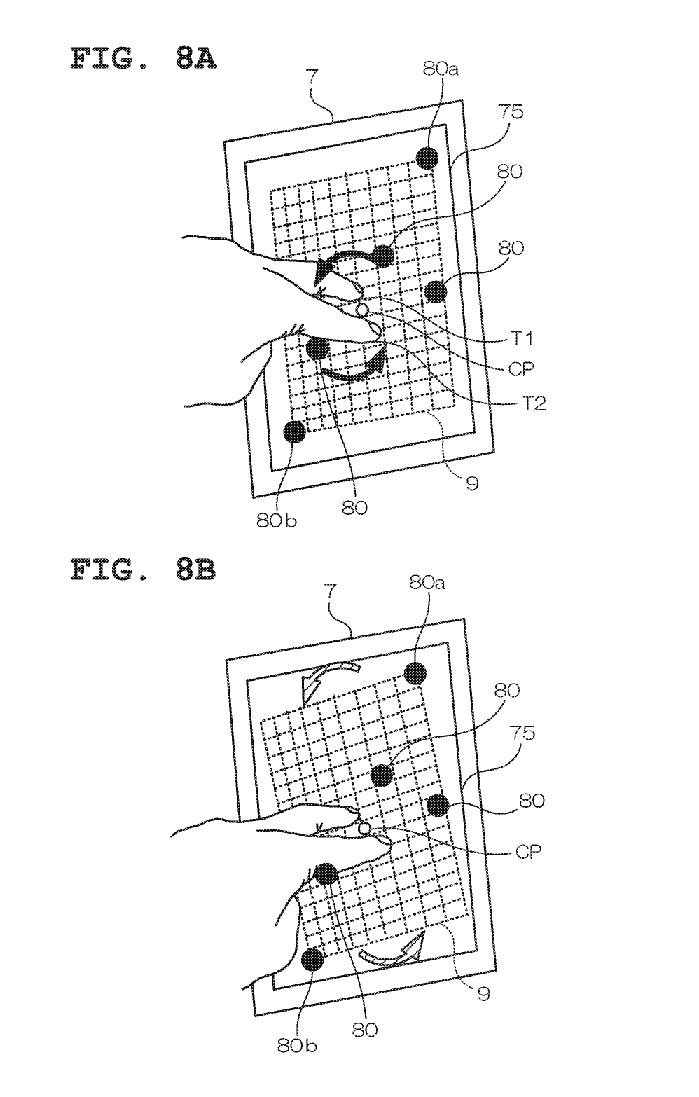

FIG. 8A and FIG, BB are schematic diagrams for describing a touch operation for rotating the mesh image 9 according to the present embodiment by operating all control points 80 simultaneously. In this rotation operation, all the control points 80 are rotated around a certain point . By this rotation operation, the mesh image 9 constituted by Bezier curves is rotated with its shape being maintained. That is, its orientation is changed with its originally straight portions being maintained, Here, a method for this operation is described, First, a point TI touched with one finger is moved to be slit in a certain direction, and a point T2 touched with another finger is moved to be slit in the opposite direction. For example, the operation section (touch panel) 75 is touched with an index finger and a middle finger, and these fingers are slid to be rotated around a center point therebetween. As a result, a rotation operation is achieved. Here, the coordinates of the points T1 and T2 touched with the two fingers and the coordinates of the center point CP between the two fingers are calculated for several frames from the start of the touch operation. Then, when the center point CP is determined to be not moving and be within an allowable range, and the movement vectors of the touched points T1 and T2 in directions opposite to each other are detected, the user's touch operation is judged to be a rotation operation.

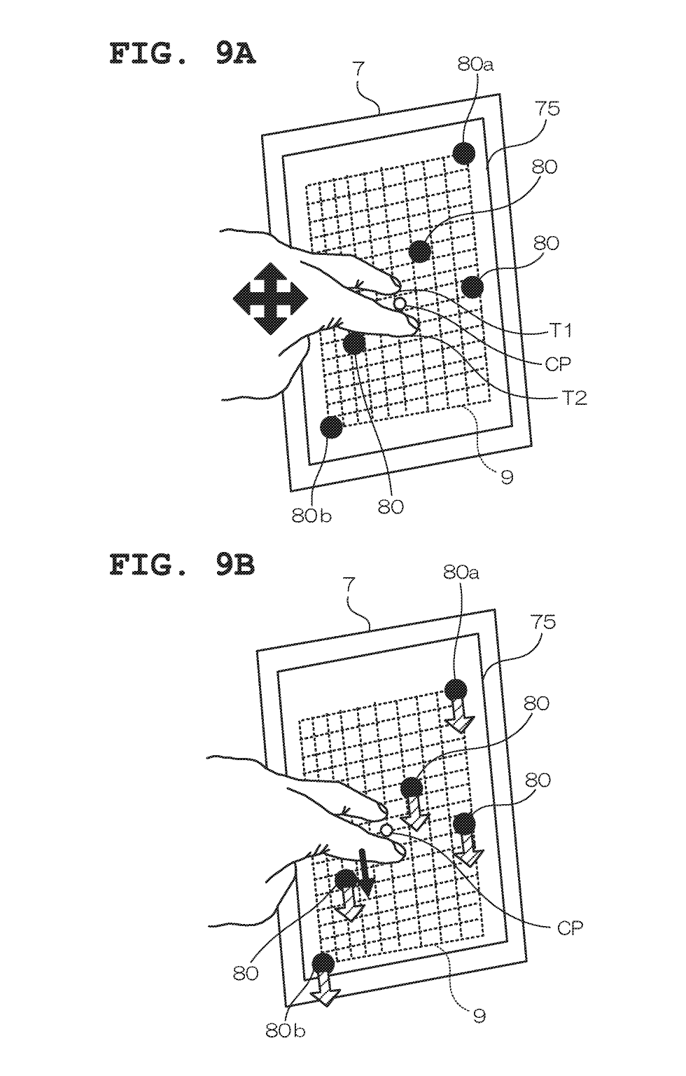

FIG. 9A and FIG. 9B are schematic diagrams for describing a touch operation for moving the mesh image 9 according to the present embodiment by operating all control points 80 parallelly and simultaneously. In this translational movement operation, all the control points 80 are moved in the same direction by the same movement amount, Here, a method for this operation is described. First, when the mesh image 9 constituted by Bezier curves is touched with two fingers, and the touched points T1 and T2 are shifted in the same direction, all the control points 80 are moved in the same direction by an amount equal to the shifting. For example, the operation section (touch panel) 75 is touched with an index finger and a middle finger, and the entire hand is moved to be slid on the screen. As a result a translational movement operation is achieved. Here, the coordinates of points T1 and T2 touched with the two fingers and the coordinates of a center point CP between the two fingers are calculated for several frames from the start of the touch operation. Then, when their movement vectors are detected to be the same in an allowable range, the user's touch operation is judged to be a translational movement operation.

In the flowchart of FIG, 4, when the user's operation is an (elongation or contraction) operation where the distance between two fingers is changed (elongation or contraction after Step S20), the CPU 77 performs elongation or contraction processing for elongating or contracting the mesh image 9 constituted by Bezier curves in accordance with the movement amounts of the two fingers performing the touch operation without changing the relative positions of control points 80 (Step S22). For example, when the two fingers touching points

T1 and T2 are moved such that the distance between the touched points T1 and T2 is lengthened as shown in FIG. 78, the mesh image 9 is elongated (enlarged) in accordance with the movement amount of the two fingers without the relative position of each control point 80 being changed. On the other hand, when the two fingers touching the points T1 and T2 are moved such that the distance between the touched points T1 and T2 is shortened as shown in FIG. 7C, the mesh image 9 is reduced in accordance with the movement amount of the two fingers without the relative position of each control point 80 being changed.

More specifically, in calculation for the elongation or contraction, the coordinates M ((xm, ym) of a center point CP between the touched points Tl and T2 are first recorded. Then, coordinates A (xa, ya) in the preceding frame and coordinates 8 (xb, yb) in the current frame are acquired for the coordinates of one touched point o Next, the distance ra between M and A and the distance rb between M and B are acquired, and the ratio of elongation or contraction c=rb/ra between the frames is acquired. Then, the vector MX between M and one control point X is multiplied by c and taken as MX′. The end point X′ of this vector indicates the coordinates of the control point after the elongation or contraction. The above-described operations are applied on all control points 80 for each frame, and the mesh image 9 is elongated or contracted by the display being updated.

As such, the mesh image 9 can be freely elongated or contracted with the shape of its straight portions being maintained. As a result, the mesh image 9 can be easily made to coincide with areas having linearity in a page image.

At Step S20, when the user's operation is an (rotation) operation where two fingers are rotated (in an arc) around a center point CP therebetween with their relative positions being maintained as shown in FIG. 8A (rotation after Step S20), the CPU 77 performs rotation processing in which the entire mesh image 9 is rotated around the center point CP between the two fingers in the rotation direction of these touching fingers by a rotation amount (rotation angle) equal to the rotation amount of the fingers , without the relative position of each control point 80 on a Bezier curve being changed (Step S24). For example, when the two fingers are rotated counterclockwise while touching as shown in FIG. 013, the mesh image 9 is rotated in the rotation direction of the two fingers in accordance with the rotation amount of the two fingers, without the relative position of each control point 80 being changed,

Specifically, there are two types of methods for deriving the rotation.

(1) A derivation method when the mesh image 9 is rotated with the center point CP between the two touched points T1 and T2 as a rotation axis.

(2) A derivation method when the movement amounts of the two touched points T1 and T2 for each frame are calculated, a rotation axis is derived for each frame, and the mesh image 9 is rotated around this axis.

In derivation method (2), although accurate derivation results can be acquired, the rotation axes are different for each frame and therefore these derivation results are unstable (the mesh image 9 is shifted for each frame). Accordingly, some sort of correction is necessary. In derivation method (1), stable derivation results can be acquired although they are slightly different from ideal results. These derivation results are not completely accurate but a sense of incongruity is not felt because a rotation axis between the fingers for each frame is not so different from the center point CP. Accordingly, derivation method (1) is described herein.

First, the coordinates M of the center point CP (xm, ym) are recorded. In a structure where the information processing terminal 7 has a function for detecting rotation angles, the detected angles may be used. In a structure where the information processing terminal 7 does not have this function, coordinates A (xa, ya) in the preceding frame and coordinates B (xb, yb) in the current frame are acquired for the coordinates of one touched point. Then, from inner product “MA·MB=|MA∥MB|cosθ” of vector MA and vector MB, cosθ (θ is a rotation angle) and sine are acquired.

Next, a control point 80 is rotated. First, the coordinates of one control point 80 are taken as X (x,y). Here, the coordinates of the control point 80 are desired to be transformed using a rotation matrix, and therefore the coordinates X are converted such that the coordinates M of the center point CP that is a rotation axis are moved to the origin.

X′=X−M=(x−xm, y−ym)=(x′,y′)

This X′ is multiplied by the rotation matrix, whereby x″=x′cosθ−y′sinθ and y″=x′sinθ+y′cosθ are acquired.

Since these coordinates are in a coordinate system where the center point is the origin, they are returned.

(x″+xm, y″+ym)

These coordinates are the coordinates of the control point 80 after the rotation. The above-described operations are applied on all control points 80 for each frame, and the mesh 20. image 9 is rotated by the. display being updated.

Regarding the above-described rotation, there is a possibility that a touch operation therefor is performed with three fingers.

In the actual use of the present invention, processing is performed in which two upper and lower Bezier curves constituting the mesh image 9 are used and rotated. That is, a center point CP when a touch operation is performed with three fingers is taken as a rotation axis, and the above-described calculation is applied to all control points 80 (five upper control points 80 and five lower control points 80: a total of ten control points 80) on the upper and lower Bezier curves. As a result the mesh image 9 is rotated with its shape being maintained.

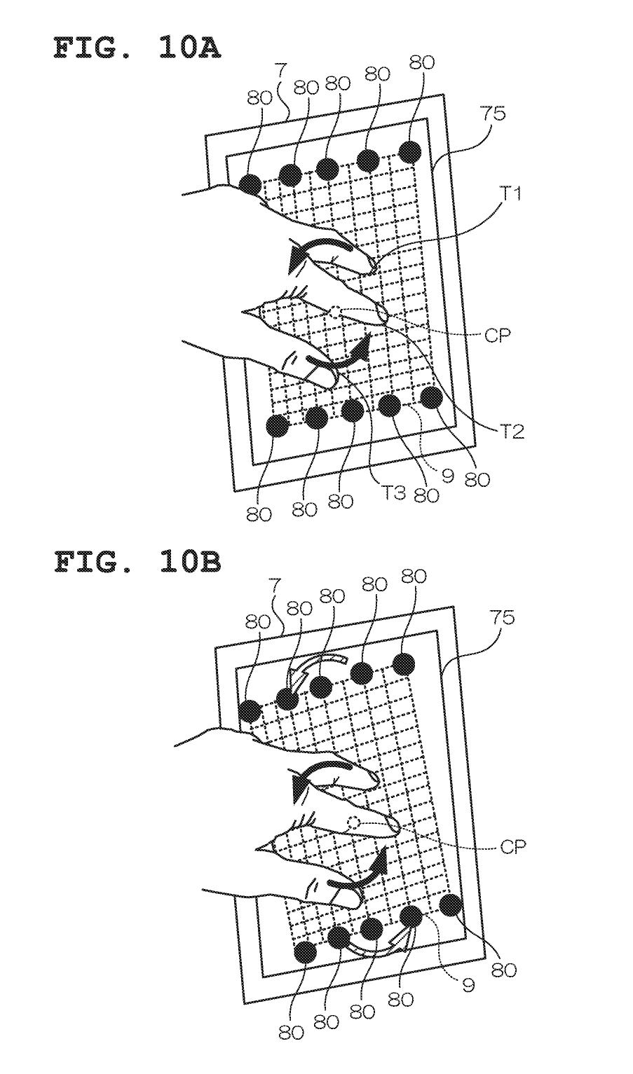

FIG. 10A and FIG. 108 are schematic diagrams for describing a touch operation using three fingers for rotating the mesh image 9 according to the embodiment. As in the case where two fingers are used, when three fingers are rotated (in an arc) around a center point CP therebetween with their relative touching positions T1, T2, and T3 being maintained as shown in FIG. 10A, the entire mesh image 9 is rotated around the center point CP between the three fingers in the rotation direction of these fingers by a rotation amount (rotation angle) equal to the rotation amount (rotation angle) of the fingers, as shown in FIG. 10B.

As such, the mesh image 9 can he freely rotated with the shape of its straight portions being maintained. Accordingly, the mesh image 9 can be easily made to coincide with areas having linearity in a page image.

At Step S20, when the user's operation is an (translational movement) operation where two fingers are moved with their relative touching positions T1 and T2 being maintained as shown in FIG. 9A (translational movement after Step S20), the CPU 77 performs translational movement processing in which the entire mesh image 9 performs a translational movement in the movement direction of the two fingers in accordance with the movement amount of the fingers, without the relative position of each control point 80 on the mesh image 9 constituted by Bezier curves being changed (Step S26). For example, when the two fingers are moved toward a lower portion of FIG. 9B, the mesh image 9 performs a translational movement in the movement direction of the two fingers in accordance with the movement amount of the fingers, without the relative position of each control point 80 being changed.

More specifically, in derivation of the translational movement, the movement vector of the center point CP is calculated based on the preceding frame and the current frame, the movement vector is added to the coordinates of the five control points 80 so as to acquire new coordinates of the control points 80, and the display of the control points 80 is updated.

As such, the mesh image 9 can he freely made to perform a translational movement with the shape of its straight portions being maintained. Accordingly, the mesh image 9 can be easily made to coincide with areas having linearity in a page image.

After deforming, elongating or contracting, rotating, or translating the mesh image 9 (control points 80) at Step S16, Step S22, Step S24, or Step S26 based on the user's touch operation, the CPU 77 superimposes the processed mesh image 9 on the page image, and outputs them on the display section 71 (Step S28). Next, the CPU 77 judges whether or not to proceed to the next processing, that is, curvature correction processing or trapezoid correction processing with respect to the page image based on the mesh image 9 (Step S30).

Here, the user views the mesh image 9 displayed at Step 528. Then, when judged that the mesh image 9 does not yet coincide with the page image, and the shape, size, angle, or position of the mesh image 9 is required be corrected, the user inputs an instruction to return to deformation processing for the mesh image 9 by a touch operation or the like. Conversely, when the mesh image 9 substantially coincides with the page image, the user inputs an instruction to proceed to the next processing by a touch operation or the like. Alternatively, a configuration may be adopted in which the user gives no instruction when the mesh image 9 does not coincide with the page image and the shape, size, angle, or position of the mesh image 9 is required be corrected, and inputs an instruction to proceed to the next processing when the mesh image 9 substantially coincides with the page image.

When an instruction to return to deformation processing for the mesh image 9 is inputted, or when an instruction to proceed to the next processing is not inputted (NO at Step S30), the CPU 77 returns to Step S12, and repeats the above-described processing for correcting the mesh image 9. Here, by predetermined touch operations being performed on the mesh image 9 displayed on the display section 71, the shape of the mesh image 9 can be sequentially deformed or the size, angle, or position of the mesh image 9 can be changed such that the processing seems to be seamless to the user.

When the user views the mesh image 9 displayed at Step S28, judges that the mesh image 9 substantially coincides with the page image, and inputs an instruction to proceed to the next processing (YES at Step S30), the CPU 77 performs curvature correction processing or trapezoid correction processing based on the current shape of the mesh image 9 so that the page image has a substantially rectangle shape (Step S32). More specifically, when the mesh image 9 has a curved shape, the CPU 77 performs curvature correction processing on the page image. When the mesh image 9 has a shape having linearity, the CPU 77 performs trapezoid correction processing on the page image. This trapezoid correction processing can be performed by an easier calculation with a small amount of calculation as compared to the curve lure correction processing. Accordingly, it is very effective that deformation processing by which a mesh image coincides with a page image with its linearity being maintained can be performed as described above Next, the CPU 77 again outputs to the display section 71 the processed page image and the mesh image 9 superimposed on the page image (Step S34).

Note that a configuration may be adopted in which, at Step S30, the CPU 77 compares the processed mesh image 9 and the page image by using image recognition, judges that the mesh image 9 substantially coincides with the page image when a predetermined condition (such as a condition that a difference between them is within an allowable range) is satisfied, and automatically proceeds to the next processing.

Next, the CPU 77 judges whether to end the processing or to deform the mesh image 9 for another page image (Step S36) Here, the user inputs an instruction to end the processing or an instruction to deform the mesh image 9 for another page image. When an instruction to deform the mesh image 9 for another page image is inputted (NO at Step S36), the CPU 77 returns to Step S10 and repeats the processing at Step 10 and the following steps on another page image (such as the next image or a page image of a page specified by the user), On the other hand, when an instruction to end the processing is inputted (YES at Step S36), the CPU 77 ends the processing.

According to the above-described embodiment, when a touch operation performed on the operation section (touch panel) 75 is a single-point operation, a control point 80 specified by the touch operation from among a plurality of control points 80 is moved in accordance with the touch operation, and whereby the shape of the mesh image 9 is deformed. When a touch operation performed on the operation section (touch panel) 75 is an multi-point operation, a plurality of control points 80 are moved under the same condition in accordance with the touch operation, and whereby the shape of the mesh image 9 is deformed. As a result of this configuration, the shape of the mesh image 9 can be freely deformed in accordance with a touch operation, and the mesh image 9 can be deformed with its linearity being maintained. That is, the shape of the mesh image 9 coincides with the shape of a page image by an easier operation.

Also, according to the above-described embodiment, when a touch operation performed on the operation section (touch panel) 75 is a touch operation performed with one finger, it is judged to be a single-point operation. When a touch operation performed on the operation section (touch panel) 75 is a touch operation performed with two or more fingers, it is judged to be a multi-point operation. As a result of this configuration, the shape of the mesh image 9 can be freely deformed by a touch operation with one finger. In addition, the mesh image 9 can be deformed with its linearity being maintained, by a touch operation with two or more fingers. That is, the shape of the mesh image 9 coincides with the shape of a page image by an easier operation.

Moreover, according to the above-described embodiment, the shape of the mesh image 9 is deformed by one control point 80 touched with one finger being moved based on the movement direction and the movement amount of the one finger dragged on the operation section (touch panel) 75. In addition, the shape of the mesh image 9 is deformed by a plurality of control points 80 being moved based on the movement directions and the movement amounts of two or more fingers dragged on the operation section (touch panel) 75. As a result of this configuration, the shape of the mesh image 9 can be freely deformed based on the movement direction and the movement amount of a touch operation performed with one finger, and the mesh image 9 can be deformed with its linearity being maintained, based on the movement directions and the movement amounts of a touch operation performed with two or more fingers. That is, the shape of the mesh image 9 coincides with the shape of a page image by an easier operation.

Furthermore, according to the above-described embodiment, when two or more fingers are moved in parallel on the operation section (touch panel) 75, a plurality of control points 80 are moved in the direction of the parallel movement by an amount equal to that of the parallel movement o As such, by a touch operation where two or more fingers are moved in parallel, the mesh image 9 performs a translational movement with its linearity being maintained. That is, the shape of the mesh image 9 coincides with the shape of a page image by an easier operation,

Still further, according to the above-described embodiment, when two or more fingers are rotated on the operation section (touch panel) 75, a plurality of control points 80 are rotated around predetermined coordinates or a rotation axis in the direction of the rotational movement by an amount equal to that of the rotational movement As such, by a touch operation where two or more fingers are rotated, the mesh image 9 is rotated with its linearity being maintained. That is, the shape of the mesh image 9 coincides with the shape of a page image by an easier operation.

Yet still further, according to the above-described embodiment, when two or more fingers are moved away from each other on the operation section (touch panel) 75, a plurality of control points 80 are moved centering on predetermined coordinates or an axis in the directions of the separation movements by amounts equal to those of the separation movements Also, when two or more fingers are moved closer to each other on the operation section (touch panel) 75, the plurality of control points 80 are moved centering on predetermined coordinates or an axis in the directions of the approach movements by amounts equal to those of the approach movements As such, by a touch operation where two or more fingers are moved closer to or away from each other, the mesh image 9 is elongated or contracted with its linearity being maintained. That is, the shape of the mesh image 9 coincides with the shape of a page image by an easier operation.

Yet still further, according to the above-described embodiment, when the mesh image 9 has a curved shape, curvature correction processing is performed on a page image thereunder. Also, when the mesh image 9 has a shape having linearity, trapezoid correction processing is performed on a page image thereunder. As such, correction processing to be performed can be selected based on the shape of the mesh image 9 and, when the mesh image 9 has a shape having linearity, trapezoid correction processing can be applied which can be performed by an easier calculation with a small amount of calculation.

While the present invention has been described with reference to the preferred embodiments, it is intended that the invention be not limited by any of the details of the description therein but includes all the embodiments which fall within the scope of the appended claims.

What is claimed is

1. An apparatus for correcting a page image, comprising:
a display control section which displays a processing target image and a mesh image superimposed thereon, on an input display section having a display function and a touch input function;
a detection section which detects a touch operation performed on the input display section by a user;
a judgment section which judges whether the touch operation detected by the detection section is a single-point operation for operating one control point from among a plurality of control points on Bezier curves constituting the mesh image or a multi-point operation for operating the plurality of control points simultaneously;
a first deformation section which deforms shape of the mesh image by moving the one control point specified by the touch operation from among the plurality of control points in accordance with the touch operation, when the judgment section judges that the touch operation is a single-point operation;
a second deformation section which deforms the shape of the mesh image by moving the plurality of control points under a same condition in accordance with the touch operation, when the judgment section judges that the touch operation is a multi-point operation; and
a correction section which corrects shape of the processing target image based on the shape of the mesh image deformed by the first deformation section and the second deformation section.

2. The apparatus according to claim 1, further comprising:
a processor which functions as at least one of the display control section, the detection section, the judgment section, the first deformation section, the second deformation section, and the correction section.

3. The apparatus according to claim 1, wherein the judgment section judges that the touch operation is a single-point operation when the touch operation performed on the input display section is a touch operation performed with one finger, and judges that the touch operation is a multi-point operation when the touch operation performed on the input display section is a touch operation performed using two or more fingers simultaneously .

4. The apparatus according to claim 3, wherein the first deformation section deforms the shape of the mesh image by moving the one control point touched with the one finger based on a movement direction and a movement amount of the one finger dragged on the input display section, and
wherein the second deformation section deforms the shape of the mesh image by moving the plurality of control points based on movement directions and movement amounts of the two or more fingers dragged on the input display section.

5. The apparatus according to claim 4, wherein the second deformation section, when the two or more fingers perform parallel movements on the input display section, moves the plurality of control points in directions of the parallel movements by amounts equal to amounts of the parallel movements

6. The apparatus according to claim 4, wherein the second deformation section, when the two or more fingers perform rotational movements on the input display section, rotates the plurality of control points in directions of the rotational movements by amounts equal to amounts of the parallel movements while centering on predetermined coordinates or a rotation axis.

7. The apparatus according to claim 4, wherein the second deformation section, when the two or more fingers perform separation movements on the input display section, moves the plurality of control points in directions of the separation movements by amounts equal to amounts of the separation movements while centering on predetermined coordinates or an axis, and
wherein the second deformation section, when the two or more fingers perform approach movements on the input display section, moves the plurality of control points in directions of the approach movements by amounts equal to amounts of the approach movements while centering on predetermined coordinates or an axis.

8. The apparatus according to claim 1, wherein the correction section performs curvature correction processing on the processing target image when the mesh image has a curved shape, and performs trapezoid correction processing on the processing target image when the mesh image has a shape having linearity.

9. A method for correcting shape of a processing target image, comprising:
displaying the processing target image and a mesh image superimposed thereon, on an input display section;
detecting a touch operation performed on the input display section by a user;
judging whether the detected touch operation is single-point operation for operating one control point from among a plurality of control points on Be ier curves constituting the mesh image or a multi-point operation for operating the plurality of control points simultaneously;
deforming shape of the mesh image by moving the one control point specified by the touch operation from among the plurality of control points in accordance with the touch operation, when the touch operation is judged to be a single-point operation;
deforming the shape of the mesh image by moving the plurality of control points under a same condition in accordance with the touch operation, when the touch operation is judged to be a multi-point operation; and
correcting the shape of the processing target image based on the deformed shape of the mesh image.

10. The method according to claim 9, wherein the touch operation is judged to be a single-point operation when the touch operation performed on the input display section is a touch operation performed with one finger, and judged to be a multi-point operation when the touch operation performed on the input display section is a touch operation performed using two or more fingers simultaneously.

11. The method according to claim 10, wherein the shape of the mesh image is deformed by the one control point touched with the one finger being moved based on a movement direction and a movement amount of the one finger dragged on the input display section, and
wherein the shape of the mesh image is deformed by the plurality of control points being moved based on movement directions and movement amounts of the two or more fingers dragged on the input display section.

12. The method according to claim 11, wherein the plurality of control points when the two or more fingers perform parallel movements on the input display section, are moved in directions of the parallel movements by amounts equal to amounts of the parallel movements.

13. The method according to claim 11, wherein the plurality of control points, when the two or more fingers perform rotational movements on the input display section, are rotated in directions of the rotational movements by amounts equal to amounts of the parallel movements while centering on predetermined coordinates or a rotation axis.

14. The method according to claim 11, wherein the plurality of control points, when the two or more fingers perform separation movements on the input display section, are moved in directions of the separation movements by amounts equal to amounts of the separation movements while centering on predetermined coordinates or an axis, and
wherein the plurality of control points, when the two or more fingers perform approach movements on the input display section, are moved in directions of the approach movements by amounts equal to amounts of the approach movements while centering on predetermined coordinates or an axis

15. A non-transitory computer-readable storage medium having stored thereon a program that is executable by a computer to actualize functions comprising:
displaying a processing target image and a mesh image superimposed thereon, on an input display section;
detecting a touch operation performed on the input display section by a user;
judging whether the detected touch operation is a single-point operation for operating one control point from among a plurality of control points on Bezier curves constituting the mesh image or a multi-point operation for operating the plurality of control points simultaneously;
deforming shape of the mesh image by moving the one control point specified by the touch operation from among the plurality of control points in accordance with the touch operation, when the touch operation is judged to be a single-point operation;
deforming the shape of the mesh image by moving the plurality of control points under a same condition in accordance with the touch operation, when the touch operation is judged to be a multi-point operation; and
correcting the shape of the processing target image based on the deformed shape of the mesh image.

16. The storage medium according to claim 15, wherein the judging judges that the touch operation is a single-point operation when the touch operation performed on the input display section is a touch operation performed with one finger, and judges that the touch operation is a multi-point operation when the touch operation performed on the input display section is a touch operation performed using two or more fingers simultaneously.

17. The storage medium according to claim 16, wherein the deforming deforms the shape of the mesh image by moving the one control point touched with the one finger based on a movement direction and a movement amount of the one finger dragged on the input display section, and
wherein the deforming deforms the shape of the mesh image by moving the plurality of control points based on movement directions and movement amounts of the two or more fingers dragged on the input display section.

18. The storage medium according to claim 17, wherein the deforming, when the two or more fingers perform parallel movements on the input display section, moves the plurality of control points in directions of the parallel movements by amounts equal to amounts of the parallel movements.

19. The storage medium according to claim 17, wherein the deforming, when the two or more fingers perform rotational movements on the input display section, rotates the plurality of control points in directions of the rotational movements by amounts equal to amounts of the parallel movements while centering on predetermined coordinates or a rotation axis.

20. The storage medium according to claim 17, wherein the deforming, when the two or more fingers perform separation movements on the input display section, moves the plurality of control points in directions of the separation movements by amounts equal to amounts of the separation movements while centering on predetermined coordinates or an axis, and
wherein the deforming, when the two or more fingers perform approach movements on the input display section, moves the plurality of control points in directions of the approach movements by amounts equal to amounts of the approach movements while centering on predetermined coordinates or an axis.
